(19) United States
(12) Patent Application Publication
(10) Pub. No.: US 2016/0031474 A1
(43) Pub. Date: Feb. 4, 2016

(54) STEERING SUPPORT YOKE

(71) Applicant: Saint-Gobain Performance Plastics Corporation, Aurora, OH (US)

(72) Inventors: Veeraraghavan Srinivasan, Chennai (IN); Ramesh Durairaj, Bangalore (IN); Srikant Gollapudi, Chennai (IN); Imam Khasim Hadimani, Bijapur (IN)

(21) Appl. No.: 14/751,910

(22) Filed: Jun. 26, 2015

(30) Foreign Application Priority Data
Jul. 30, 2014 (IN) 3698/CHE/2014

(51) Int. Cl. B62D 3/12; C22F 1/047; C22C 21/08

(52) U.S. Cl. CPC B62D 3/123; C22C 21/08; C22F 1/047

(57) ABSTRACT

A process of forming a support yoke can include providing a material; shaping the material to form a rough shape, wherein shaping is performed at a temperature less than a melting temperature of the material; and heat treating the rough shape. In an embodiment, heat treating can include solutionizing and ageing. In an embodiment, the process can include machining. In an embodiment, the support yoke can be used in a rack and pinion assembly. In an embodiment, the support yoke can be a steering yoke.

### CROSS-REFERENCE TO RELATED APPLICATION

This application claims priority under 35 U.S.C. §119(b) to Indian Patent Application No. 3698/CHE/2014 entitled “STEERING SUPPORT YOKE,” by Veeraraghavan Srinivasan, et al., filed Jul. 30, 2014, which is assigned to the current assignee hereof and incorporated herein by reference in its entirety.

### FIELD OF THE DISCLOSURE

The present disclosure relates to support yokes, and more particularly to forged support yokes.

### RELATED ART

Typically, vehicles use a rack and pinion gear assembly to translate motion from a steering wheel to the wheels on the road. In these systems, the steering wheel is joined to a pinion gear that includes gear teeth that are mated with teeth on a rack shaft. As the pinion gear rotates, the motion is translated into linear motion of the rack shaft that is connected to tie rods. The tie rods then rotate the turning wheels, causing the vehicle to turn. To assure proper lash between the pinion and the rack shaft, a steering support yoke assembly may be used to provide a biasing force that forces the rack into the pinion gear. The support yoke may also be referred to as a “support yoke assembly,” “support yoke slipper,” or “puck.” The rack shaft (typically steel) slides along the support yoke when the pinion gear is rotated. Friction between the shaft and the support yoke can be minimized by using a low friction bearing on the contact surface of the support yoke. These steering systems may be mechanical, hydraulic or electric.

There continues to exist a need for improved support yokes and methods of forming the same.

### BRIEF DESCRIPTION OF THE DRAWINGS

Embodiments are illustrated by way of example and are not limited in the accompanying figures.

FIG. 1 includes a perspective view of a typical steering assembly in accordance with an embodiment.

FIG. 2 includes a cutaway view of a portion of a rack and pinion steering system in accordance with an embodiment.

FIG. 3 includes an SEM image of a microstructure as viewed in a die cast support yoke.

FIG. 4 includes an SEM image of a microstructure as viewed in a forged support yoke in accordance with an embodiment.

FIG. 5 includes a perspective view of a forged support yoke in accordance with an embodiment.

FIG. 6 includes a flow chart illustrated an arrangement of the steps of a process of forming a support yoke in accordance with an embodiment.

FIG. 7 includes a graphical comparison of the relative stiffness of die-cast and cold forged support yokes.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the support yoke arts.

A process of forming a support yoke in accordance with one or more of the embodiments described herein can generally include providing a material and shaping the material to form a rough shape, where shaping is performed at a temperature less than a melting temperature of the material. The process can further include machining the rough shape to form the support yoke. In an embodiment, shaping the material can be performed by forging. In a more particular embodiment, shaping the material can be performed by cold forging. For example, shaping can be performed by a press, such as a hydraulic press.

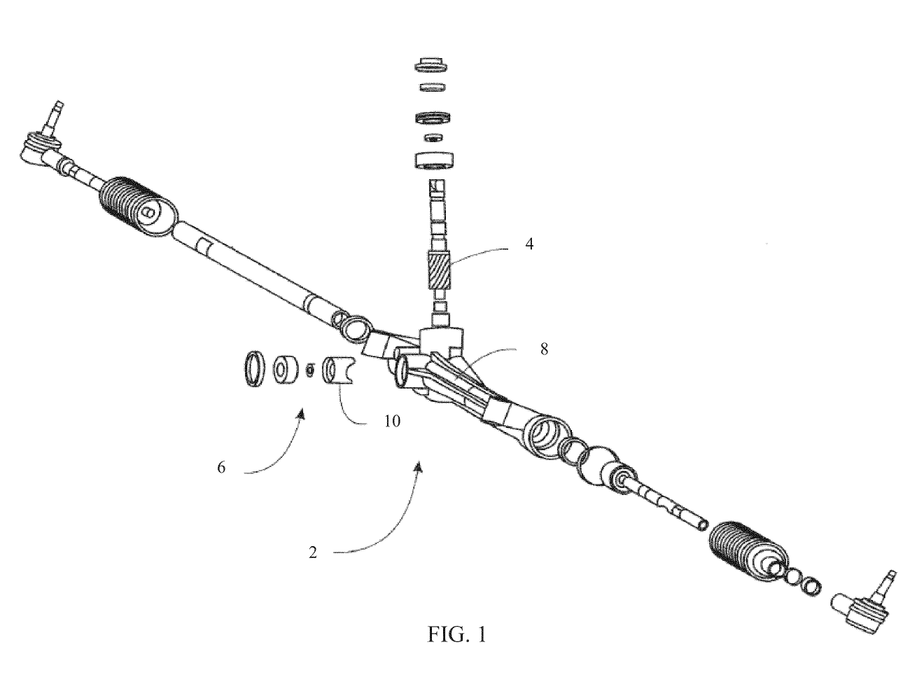

Referring now to the figures, FIG. 1 includes an exploded view of a steering assembly 2. The assembly includes a helical pinion gear 4 mated with teeth on a rack shaft (not illustrated in FIG. 1). A support yoke assembly 6 is inserted into a pinion housing 8 and provides a biasing force, causing the rack shaft to maintain proper lash with the pinion gear 4. Specifically, the support yoke assembly 6 can include a support yoke 10 providing a biasing force between the rack shaft with the pinion gear 4. The system may be lubricated with a grease, e.g., a lithium grease.

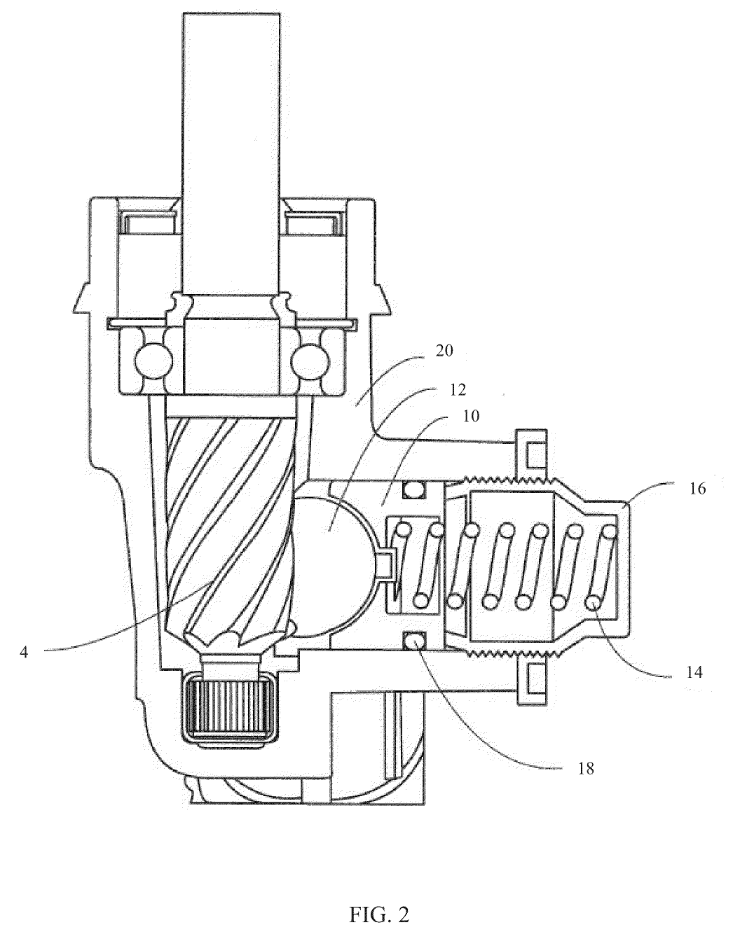

FIG. 2 includes a cutaway view of a portion of the steering assembly 2 of FIG. 1. The pinion gear 4 is mated with the rack shaft 12 which maintains mechanical contact with the aid of the support yoke 10. The support yoke 10 is biased against the pinion gear 4 by a spring 14. The spring 14 is compressed and retained by a cap 16. The cap 16 can be secured to a housing 20, for example, by a threaded engagement. An O-ring 18 can be seated in a channel that circumscribes the support yoke 10. The O-ring 18 may also be seated in a groove that circumscribes the inner surface of the housing 20. When an operator turns the steering wheel of the vehicle, the pinion gear 4 rotates, causing the rack shaft 12 to slide either into or out of the page as configured in FIG. 2. The rack shaft 12 slides against a stationary support yoke 10 which maintains a biasing force that keeps the gear and shaft meshed together. A stronger biasing force can help to achieve a less noisy steering mechanism, however, if a stronger force is provided by a spring 14 a greater amount of friction and resulting wear will occur between the support yoke 10 and the rack shaft 12.

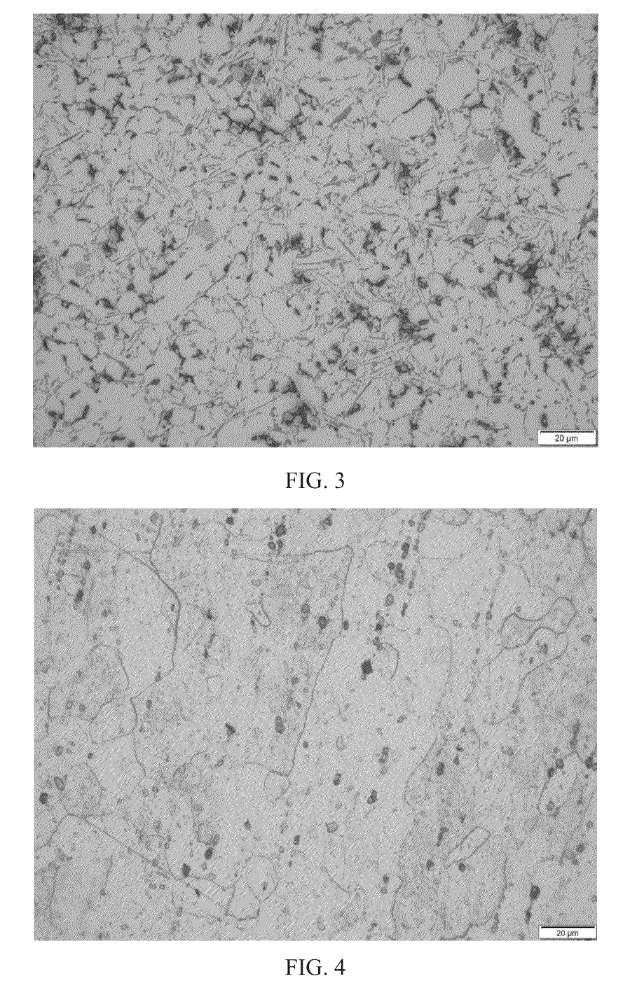

Existing support yokes are typically made from die cast metallic alloy or injection molded plastic. It has been found that these support yokes suffer repeated loading and thermal cycling problems in usage and excessive melting associated material loss. For example, die casting a support yoke may introduce various porosities, shrinkage cavities, microstructures, blow holes, pin holes, or oxides into the support yoke body. Additionally, during die casting the initial layer of molten metal poured into the shot sleeve may solidify first and break into small parts which distribute into the remaining molten metal as flakes. These flakes may be referred to as cold flakes. These cold flakes can form a non-homogenous support yoke body microstructure which may reduce mechanical properties thereof. Specifically, as the microstructure becomes less uniform, e.g., by inclusion of more cold flakes, blow holes, pin holes, porosities, or oxides, the mechanical strength of the support yoke can decrease. FIG. 3 illustrates an SEM image of a microstructure of a pressure die cast support yoke as seen along a section line. A number of pores are visible with at least three morphological phases present. A first phase may include white grains or particles rich in aluminum, iron, and silicon, such as an intermetallic Al₃(Fe, Si, Mn, Cr). A second phase may include gray grains that are aluminum rich with very low weight percentages of zinc, copper, and silicon. A third phase may include finely distributed small grains which are rich in aluminum, silicon, copper, and zinc. While the intermetallics may impart strength to the material, the presence of aluminum rich regions may reduce the overall strength of the material, as aluminum is relatively soft independent of its alloying elements—copper, zinc, and silicon. Additionally, the intermetallics may cause the material to become brittle by acting as crack initiating sites upon deformation loading conditions.

It has been found that a forged support yoke can be used to minimize, or eliminate, these mechanical weaknesses. Specifically, forging can create a more homogenous microstructure (FIG. 4) and a support yoke having increased strength as compared to a similar die cast support yoke. More specifically, forging may break down the dendritic structure of the support yoke material. This may lead to more isotropic properties of the support yoke. Additionally, forging may introduce plastic deformation into the microstructure. Such plastic deformation may provide higher precipitation nucleating sites leading to finer distribution of precipitates in the support yoke material. Moreover, precipitates of AlMgSi present in the microstructure of the forged support yoke may increase the mechanical properties, e.g., hardness and compressive strength, of the support yoke.

The higher strength associated with a forged support yoke requires a relative increase in manufacturing time and expense as compared to traditional die cast and injection molded designs. Forging requires a multi-step, multi-machine process demanding increased operator time, resources, and machining. Between forging processes, the forged support yoke is transferred between machines, requiring movable racks or assembly lines and additional production floor space. The precision machines and dies necessary to forge a precise support yoke are typically expensive and costly to operate and maintain. Moreover, ingots of raw material must be of sufficient mechanical properties as provided as the material will not be brought to a molten state.

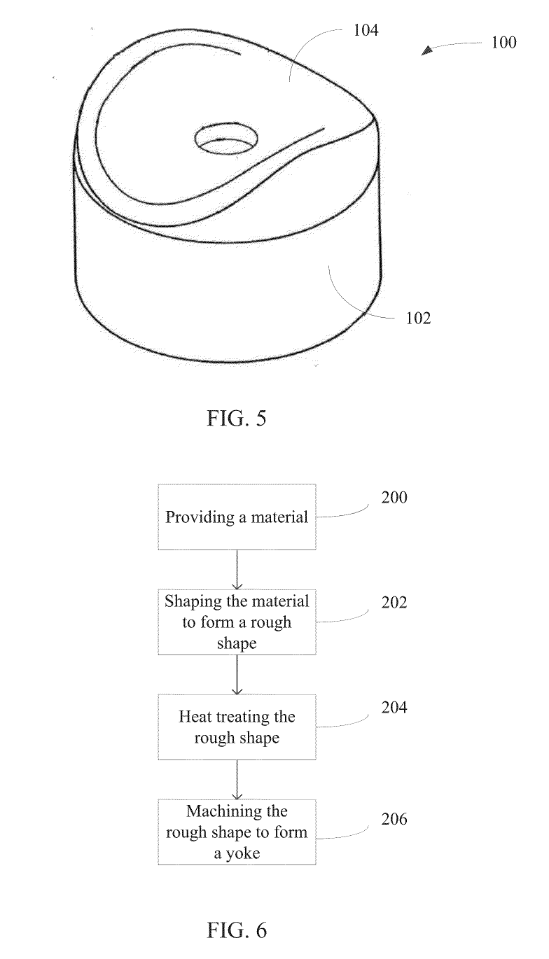

FIG. 5 includes a perspective view of a support yoke 100 in accordance with an embodiment described herein. The support yoke 100 generally includes a sidewall 102 and an arcuate upper surface 104. The sidewall 102 and the arcuate upper surface 104 may be contiguous. Moreover, the sidewall 102 and the arcuate upper surface 104 may be unitary, e.g., formed by monolithic construction.

In an embodiment, the sidewall 102 may define an internal cavity within the support yoke 100. The internal cavity can define an inner diameter of the sidewall 102. The inner diameter can be in a range of 20 mm and 40 mm, such as in a range of 25 mm and 35 mm, or even in a range of 30 mm and 31 mm. The outer diameter of the sidewall 102 may be in a range of 20 mm and 40 mm, such as in a range of 25 mm and 35 mm, or even in a range of 30 mm and 31 mm. In a particular embodiment, the sidewall 104 can have a constant thickness.

The spring 14 (FIG. 2) can be inserted at least partially into the internal cavity of the support yoke and bias against a spring perch disposed under the arcuate upper surface. A biasing force provided by the spring 14 can urge the arcuate upper surface 104 of the support yoke 100 into the rack shaft 12, thereby maintaining a proper lash between the rack shaft 12 and the pinion gear 4.

In an embodiment, the support yoke 100 can have a Vickers Pyramid Number (Vickers Hardness) of at least 125, such as at least 126, at least 127, at least 128, at least 129, or even at least 130. In another embodiment, the Vickers Hardness can be no greater than 150, such as no greater than 145, or even no greater than 140. It has been found that die casted support yokes exhibit a Vickers Hardness of less than 125. Accordingly, die cast support yokes deform more readily upon exposure to loading conditions such as those encountered in steering assemblies.

In a particular embodiment, the arcuate upper surface 104 of the support yoke 100 can include a low friction material. The low friction material can include a polymer, such as for example, a fluoropolymer. The low friction material may be adhered to the arcuate upper surface 104 by, for example, mechanical adhesion or lamination with a hot melt adhesive. The fluoropolymer may be, for example, a PTFE. The low friction material may include one or more fillers such as graphite, glass, aromatic polyester (EKONOL®), bronze, zinc, boron nitride, carbon and/or polyimide. One embodiment includes both graphite and polyester fillers. Concentrations of each of these fillers in a polymer such as PTFE may be greater than 1%, greater than 5%, greater than 10%, greater than 20% or greater than 25% by weight. Additional layers, such as a bronze mesh between the arcuate upper surface 104 and the low friction material, or embedded in the low friction material, may also be used. Such materials include the NORGLIDE® line of products available from Saint-Gobain Performance Plastics Inc. Suitable examples of NORGLIDE products include NORGLIDE PRO, M, SM, T and SMTL. The thickness of the low friction material may vary or be constant across the arcuate upper surface 104. The low friction material may have an average thickness of greater than or equal to 30 μm, 50 μm, 75 μm, 100 μm, 150 μm, 200 μm, or 250 μm. Thicker low friction materials have been shown to provide a more consistent bearing load over the life of the support yoke 100.

In a further embodiment, the upper arcuate surface 104 or low friction material may be textured such that some portions of the surface are higher than other portions. Texturing may include a plurality of peaks and valleys. The peaks may measure greater than or equal to 10 μm, 20 μm, 50 μm, 100 μm or 200 μm above the adjacent valley. The texturing of the surface can provide numerous reservoirs for retaining grease. The texture may be patterned or random and can be consistent across the surface. In one embodiment, a patterned textured surface may be formed by depositing a fluorocarbon layer over a screen, such as a bronze mesh. When assembled, the smooth surface of the steel rack shaft may contact the support yoke at numerous high points, or peaks, across the contact surface. Contact points may be distributed across the surface so that the force between the support yoke and the rack shaft is born by a large portion of the arcuate region. For example, the contact points may be found on more than 50%, more than 70%, more than 80% or more than 90% of the arcuate surface region. The force may be substantially equally distributed between central and edge portions of the arcuate region. Thus, the pressure exerted by the support yoke against the cylindrical rack shaft may be substantially equivalent across the width and length of the bearing surface.

FIG. 6 includes an exemplary flow diagram of a process for forming the support yoke 100 in accordance with one or more of the embodiments described herein. The process can generally include a first step 200 of providing a material, a second step 202 of shaping the material, a third step 204 of heat treating the material, and a fourth step 206 of machining the material. A skilled artisan will understand after reading the entire disclosure that each of the four steps can include any number of sub-steps or additional steps. Moreover, a skilled artisan will understand that the four steps may be performed in a different order. However, it has been found that use of a different order may reduce strength and effectiveness of the support yoke 100.

The first step 200 of the process includes providing a material. The material can generally include an aluminum, or aluminum-containing, material. In a particular embodiment, the material can include an aluminum alloy. In another embodiment, the material can include at least 95 wt. % aluminum, such as at least 95.5 wt. % aluminum, at least 96 wt. % aluminum, at least 96.5% wt. % aluminum, at least 97 wt. % aluminum, at least 97.5 wt. % aluminum, or even at least 98 wt. % aluminum. In a more particular embodiment, the material can include a material having at least 95.8 wt. % aluminum and no greater than 98.6 wt. % aluminum. The material can further include silicon, magnesium, chromium, copper, iron, manganese, tin, zinc, or a combination thereof. The material can include silicon in a range of 0.4 wt. % to 0.8 wt. %. The material can include magnesium in a range of 0.8 wt. % to 1.2 wt. %. The material can include chromium in a range of 0.04 wt. % to 0.35 wt. %. The material can include copper in a range of 0.15 wt. % to 0.4 wt. %. The material can include no greater than 0.7 wt. % iron. The material can include no greater than 0.15 wt. % manganese. The material can include no greater than 0.15 wt. % tin. The material can include no greater than 0.25 wt. % zinc.

In an embodiment, the material can have an ultimate tensile strength of no greater than 125 MPa, such as no greater than 120 MPa, no greater than 115 MPa, or even no greater than 110 MPa. In a further embodiment, the material can have an ultimate tensile strength of no less than 50 MPa, such as no less than 75 MPa, or even no less than 100 MPa. In another embodiment, the material can have a maximum yield strength of no greater than 80 MPa, such as no greater than 70 MPa, no greater than 60 MPa, no greater than 50 MPa, or even no greater than 40 MPa. In a further embodiment, the material can have a maximum yield strength of no less than 10 MPa, such as no less than 20 MPa, or even no less than 30 MPa. In yet another embodiment, the material can have an elongation at break in a range of 10% and 50%, such as in a range of 15% and 40%, in a range of 20% and 35%, or even in a range of 25% and 30%.

In a more particular embodiment, the material can be formed from an aluminum 6061 alloy.

As provided in the first step 200, the material can be in the shape of an ingot. The material can be operated on to form smaller blanks for forging. In a particular embodiment, the smaller blanks can be at least 15 grams, such as at least 20 grams, at least 25 grams, or even at least 30 grams. In another embodiment, the smaller blanks can be no greater than 50 grams, such as no greater than 45 grams, no greater than 40 grams, or even no greater than 35 grams. Moreover, the smaller blanks can be within a range of 15 grams and 50 grams, such as within a range of 20 grams and 45 grams, within a range of 25 grams and 40 grams, or even within a range of 30 grams and 35 grams. In a more particular embodiment, a standard deviation between the smaller blanks can be no greater than 5 grams, such as no greater than 4 grams, no greater than 3 grams, no greater than 2 grams, or even no greater than 1 gram. More particularly, the standard deviation can be less than 0.5 grams, such as less than 0.25 grams, less than 0.1 grams, or even less than 0.05 grams.

The second step 202 of the process includes shaping the material to form a rough shape. The rough shape can have an annular sidewall and an arcuate upper surface, generally similar to the support yoke 100 as described above. In an embodiment, the second step 202 can be performed at a temperature less than a melting temperature of the material. For example, for an aluminum 6061 alloy, shaping may be performed at a temperature of less than 550° C., such as less than 500° C., less than 450° C., less than 400° C., less than 350° C., less than 300° C., less than 250° C., less than 200° C., less than 150° C., less than 100° C., less than 50° C., or even less than 0° C. Shaping at a temperature below the melting point of the material is intended to explicitly exclude the use of die casting, pressure die casting, injection molding, or any other similar process utilizing a molten material.

In a particular embodiment, the second step 202 can be performed by application of a compressive force, such as, for example, by forging. More particularly, the second step 202 can be performed by cold forging. As discussed above, this can result in a single phase microstructure, increasing the strength of the material. Cold forging can be performed at, or near room temperature.

In an embodiment, the second step 202 of the process can include inserting the material into a shaping tool, engaging the shaping tool to shape the material into a rough shape, and removing the rough shape from the shaping tool. In a particular embodiment, the shaping tool can be a press, such as, for example, a hydraulic press, a pneumatic press, or a mechanical press. The shaping tool can provide at least 100 tons of force to shape the unshaped material, such as at least 115 tons of force, at least 130 tons of force, at least 145 tons of force, at least 150 tons of force, at least 200 tons of force, or even at least 250 tons of force. In another embodiment, the shaping tool can provide no greater than 500 tons of force.

In a particular embodiment, a hydraulic press may be utilized to shape the material into a rough shape. In yet a more particular embodiment, the hydraulic press may have a cylinder pressure in a range of 10 MPa and 15 MPa, such as approximately 12 MPa; an ejector pressure in a range of 1 MPa and 5 MPa, such as approximately 2 MPa; a cycle time in a range of 2 seconds to 30 seconds, such as approximately 18 seconds; a cut off in a range of 120 mm and 175 mm, such as approximately 150 mm; a slow in a range of 500 mm and 700 mm, such as approximately 600 mm; an end cut off in a range of 600 mm and 800 mm, such as approximately 720 mm; and an oil temperature in a range of 25° C. and 75° C., such as approximately 50° C.

In accordance with one or more of the embodiments described herein, the second step 202 can be adapted to be repeated to form at least 50,000 rough shapes before replacement of the shaping tool, such as at least 55,000 rough shapes, at least 60,000 rough shapes, at least 65,000 roughs shapes, at least 70,000 rough shapes, or even at least 75,000 rough shapes. Replacement of the shaping tool may include replacement of one or more dies contained in the shaping tool or other equipment of the shaping tool used in forming a compressive force. In an embodiment, the second step 202 can be adapted to repeatedly form no greater than 1,000,000 rough shapes before replacement of the shaping tool.

The third step 204 of the process includes heat treating the rough shape. In an embodiment, the third step 204 can be performed by precipitation hardening. In another embodiment, the third step 204 can be performed by solutionizing and ageing the rough shape. More particularly, solutionizing can be affected at a temperature in a range of 450° C. to 600° C., such as in a range of 500° C. and 550° C. In a particular embodiment, solutionizing can be affected at approximately 530° C. More particularly, solutionizing can be performed for a time in a range of 200 minutes to 300 minutes, such as in a range of 230 minutes to 250 minutes, or even 235 minutes to 245 minutes. In a particular embodiment, solutionizing can be performed for approximately 240 minutes. Following solutionizing, the rough shape can be aged at a temperature in a range of 150° C. and 200° C., such as in a range of 160° C. and 190° C., or even in a range of 170° C. and 180° C. In a particular embodiment, ageing can be performed at approximately 175° C. It is noted that at 175° C., an optimum material strength is achieved. In an embodiment, ageing can be performed for a time in a range of 400 minutes and 550 minutes, such as in a range of 450 minutes and 500 minutes. In a particular embodiment, ageing can be performed for approximately 480 minutes.

The third step 204 can further include quenching the rough shape. In a particular embodiment, quenching can be performed after solutionizing and prior to ageing. In a more particular embodiment, quenching can occur immediately after solutionizing. In such a manner, the rough shape can be quenched within no greater than 30 minutes after solutionizing, such as within no greater than 15 minutes after solutionizing, within no greater than 5 minutes after solutionizing, or even no greater than 1 minute after solutionizing.

In an embodiment, quenching can be performed by at least partially submerging the rough shape into a vessel with a liquid. More particularly, quenching can be performed by fully submerging the rough shape into a vessel with a liquid. In an embodiment, the liquid can include water. In an embodiment, the liquid can be at approximately room temperature. However, quenching can occur at a range of temperatures at or above room temperature. In a particular embodiment, quenching can have a duration of at least 1 minute, such as at least 2 minutes, at least 3 minutes, at least 4 minutes, or even at least 5 minutes. In a further embodiment, quenching can have a duration of no greater than 50 minutes, such as no greater than 40 minutes, no greater than 30 minutes, no greater than 20 minutes, no greater than 10 minutes, or even no greater than 6 minutes. In a particular embodiment, quenching can have a duration of approximately 5 minutes.

In an embodiment, the third step 204 can further include cooling the rough shape at or near room temperature. In a more particular embodiment, cooling can occur after solutionizing is complete. In particular, the rough shape can be removed from the solutionizing oven and slowly reduced to room temperature. In accordance with one or more embodiments, it may take at least 10 minutes for the rough shape to cool, such as at least 20 minutes, or even at least 30 minutes. At the termination of cooling, the rough shape may be at, or near, room temperature. At such time, it may be appropriate to proceed to the fourth step 206.

In an embodiment, the rough shape can have an ultimate tensile strength of at least 275 MPa, such as at least 280 MPa, at least 285 MPa, at least 290 MPa, at least 295 MPa, at least 300 MPa, or even at least 305 MPa. In another embodiment, the rough shape can have an ultimate tensile strength of no greater than 400 MPa, such as no greater than 375 MPa, no greater than 350 MPa, no greater than 340 MPa, no greater than 330 MPa, no greater than 325 MPa, no greater than 320 MPa, or even no greater than 315 MPa. In yet another embodiment, the rough shape can have a maximum yield strength of at least 245 MPa, such as at least 250 MPa, at least 255 MPa, at least 260 MPa, at least 265 MPa, or even at least 270 MPa. In a further embodiment, the rough shape can have a maximum yield strength of no greater than 300 MPa, such as no greater than 295 MPa, no greater than 290 MPa, no greater than 285 MPa, or even no greater than 280 MPa. In another embodiment, the rough shape can have an elongation at break of at least 5%, such as at least 6%, at least 7%, at least 8%, at least 9%, at least 10%, at least 11%, or even at least 12%. In yet another embodiment, the rough shape can have an elongation at break of no greater than 20%, such as no greater than 19%, no greater than 18%, or even no greater than 17%. In a particular embodiment, the rough shape can have an elongation at break in a range of 10% and 20%, such as in a range of 12% and 18%.

The fourth step 206 of the process includes machining the rough shape to form a support yoke 100. Machining can include, for example: milling, grinding, polishing, sanding, sandblasting, ablating, or performing any combination thereof on the rough shape. In a particular embodiment, at least one circumferential channel can be formed in the support yoke sidewall 102. An O-ring can be disposed within the circumferential channel. The O-ring can align the support yoke 100 within the housing 20 (FIG. 2) and increase performance of the assembly.

After performance of the fourth step 206, the support yoke 100 can have a surface roughness, Rₐ, of no greater than 0.6 microns, as measured by a Mitutoyo Surface Roughness measuring tester Model SJ-210 having a 4 mm measuring length. As used herein, “surface roughness” refers to the average height of the peaks and troughs of the measured profile within the measuring length. In a further embodiment, Rₐ can be no greater than 0.55 microns, such as no greater than 0.53 microns, no greater than 0.51 microns, no greater than 0.49 microns, no greater than 0.48 microns, no greater than 0.47 microns, or even no greater than 0.46 microns. In yet a further embodiment, Rₐ can be at least 0.35. A die cast support yoke generally exhibits a surface roughness of at least 0.65 microns, and more typically has a surface roughness between 0.85 microns and 0.90 microns. Reduced surface roughness, Rₐ, may enhance sliding properties of the support yoke 100, thereby providing a smoother experience with less stiction and frictional resistance.

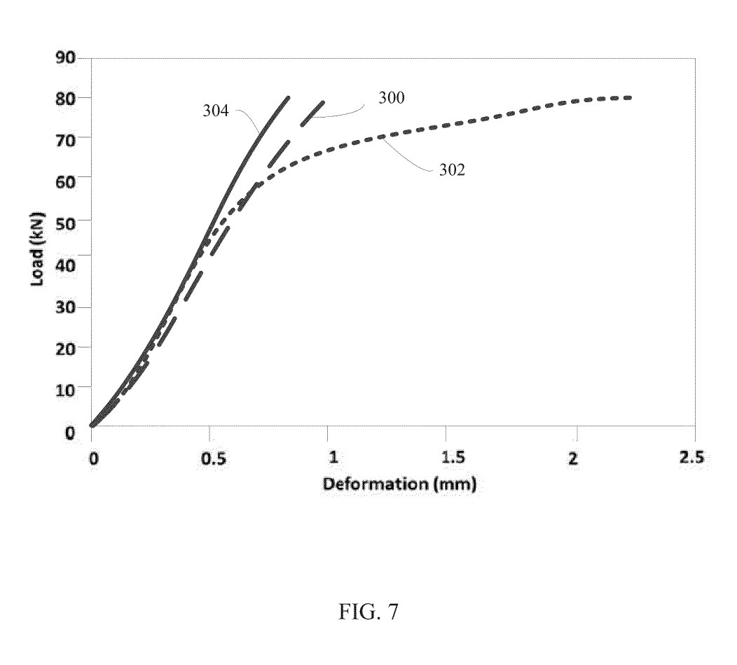

FIG. 7 includes a graph comparing the relative strengths of a die cast support yoke, a non-heat treated forged support yoke, and a heat treated forged support yoke in accordance with an embodiment described above. Each of the support yokes has the same, or substantially the same, configuration, size, and spatial arrangement. As illustrated, the non-heat treated, forged support yoke (represented by line 300) has a stiffness less than that of a similar die-cast support yoke (represented by line 302). As such, skilled artisans have avoided use of forged support yokes as prolonged usage of the support yoke within a rack and pinion assembly fails after repeated cycling. To the contrary, a heat treated, forged support yoke (represented by line 304) has a higher stiffness as compared to the die cast support yoke 302. As such, the heat treated, forged support yoke 304 is stronger than the die cast support yoke 302 over a range of loading conditions.

Many different aspects and embodiments are possible. Some of those aspects and embodiments are described below. After reading this specification, skilled artisans will appreciate that those aspects and embodiments are illustrative and do not limit the scope of the present invention. Embodiments may be in accordance with any one or more of the items as listed below.

Item 1. A process of forming a support yoke comprising:

providing a material;
shaping the material to form a rough shape, wherein shaping is performed at a temperature less than a melting temperature of the material; and
heat treating the rough shape.

Item 2. The process of item 1, wherein the process of shaping is adapted to be repeated to form at least 50,000 rough shapes before replacement of a shaping tool used to shape the rough shape, such as at least 55,000 rough shapes, at least 60,000 rough shapes, at least 65,000 rough shapes, at least 70,000 rough shapes, or even at least 75,000 rough shapes.

Item 3. The process of any one of the preceding items, wherein the process of shaping is performed by application of a compressive force.

Item 4. The process of any one of the preceding items, wherein the process of shaping is performed by forging.

Item 5. The process of any one of the preceding items, wherein the process of shaping is performed by cold forging.

Item 6. The process of any one of the preceding items, wherein the process of shaping further comprises:

inserting the material into a shaping tool;
engaging the shaping tool to shape the material into a rough shape; and
removing the rough shape from the shaping tool.

Item 7. The process of item 6, wherein the shaping tool is adapted to provide at least 100 tons of force to shape the unshaped material, such as at least 115 tons of force, at least 130 tons of force of force, at least 145 tons of force, at least 150 tons of force, at least 200 tons of force, or even at least 250 tons of force.

Item 8. The process of any one of items 6 and 7, wherein the shaping tool comprises a press.

Item 9. The process of any one of the preceding items, wherein the process further comprises:

machining the rough shape to form a support yoke.

Item 10. The process of item 9, wherein the process of machining further includes: milling, grinding, polishing, sanding, sandblasting, ablating, or a combination thereof.

Item 11. The process of any one of the preceding items, wherein the process of heat treating is performed by precipitation hardening.

Item 12. The process of any one of the preceding items, wherein the process of heat treating is performed by:

solutionizing the support yoke; and
ageing the support yoke.

Item 13. The process of item 12, wherein solutionizing is affected in a range of 450° C. to 600° C.

Item 14. The process of any one of items 12 and 13, wherein solutionizing is affected at approximately 530° C.

Item 15. The process of any one of items 12-14, wherein solutionizing is performed in a range of 200 minutes to 300 minutes.

Item 16. The process of any one of items 12-15, wherein solutionizing is performed in a range of 230 minutes to 250 minutes.

Item 17. The process of any one of items 12-16, wherein solutionizing is performed for approximately 240 minutes.

Item 18. The process of any one of items 12-17, wherein ageing is affected in a range of 150° C. to 200° C.

Item 19. The process of any one of items 12-18, wherein ageing is affected at approximately 175° C.

Item 20. The process of any one of items 12-19, wherein ageing is performed in a range of 400 minutes and 550 minutes.

Item 21. The process of any one of items 12-20, wherein ageing is performed for approximately 480 minutes.

Item 22. The process of any one of items 12-21, wherein the process of heat treating further comprises:

quenching the support yoke after solutionizing.

Item 23. The process of item 22, wherein quenching is performed in a range of 1 minute to 50 minutes.

Item 24. The process of any one of items 22 and 23, wherein quenching is performed for approximately 5 minutes.

Item 25. The process of any one of items 22-24, wherein quenching is performed by at least partially submerging the support yoke in a fluid.

Item 26. The process of any one of items 22-25, wherein quenching is performed by fully submerging the support yoke in a fluid.

Item 27. The process of any one of items 22-26, wherein quenching is performed by at least partially submerging the support yoke in a water.

Item 28. The process of any one of the preceding items, further comprising:

cooling the support yoke to a temperature in a range of 10° C. and 100° C.

Item 29. The process of any one of the preceding items, further comprising:

cooling the support yoke to a temperature of approximately 22° C.

Item 30. The process of any one of the preceding items, wherein the material at least partially comprises an aluminum.

Item 31. The process of any one of the preceding items, wherein the material comprises at least 95 wt. % aluminum, such as at least 95.5 wt. % aluminum, at least 96 wt. % aluminum, at least 96.5% wt. % aluminum, at least 97 wt. % aluminum, at least 97.5 wt. % aluminum, or even at least 98 wt. % aluminum.

Item 32. The process of any one of the preceding items, wherein the material comprises at least 95.8 wt. % aluminum.

Item 33. The process of any one of the preceding items, wherein the material comprises an aluminum alloy.

Item 34. The process of any one of the preceding items, wherein the material comprises magnesium.

Item 35. The process of any one of the preceding items, wherein the material comprises at least 0.8 wt. % magnesium.

Item 36. The process of any one of the preceding items, wherein the material comprises an aluminum 6061 alloy.

Item 37. The process of any one of the preceding items, wherein the support yoke comprises a single phase morphology.

Item 38. The process of any one of the preceding items, wherein the support yoke has a more uniform morphology as compared to a steering support yoke formed by a die casting process.

Item 39. The process of any one of the preceding items, wherein the support yoke has an average surface roughness, Rₐ, of no greater than 0.6 microns, such as no greater than 0.55 microns, such as no greater than 0.53 microns, no greater than 0.51 microns, no greater than 0.49 microns, no greater than 0.48 microns, no greater than 0.47 microns, or even no greater than 0.46 microns.

Item 40. The process of any one of the preceding items, wherein the support yoke has a Vickers Hardness of at least 125, such as at least 126, at least 127, at least 128, at least 129, or even at least 130.

Item 41. The process of any one of the preceding items, wherein the support yoke has a Vickers Hardness of no greater than 150, such as no greater than 145, or even no greater than 140.

Item 42. The process of any one of the preceding items, wherein the support yoke has a body defining a sidewall and an arcuate upper surface.

Item 43. The process of item 42, wherein the arcuate upper surface is contiguous with the sidewall.

Item 44. The process of any one of items 42 and 43, wherein the sidewall defines an internal cavity of the support yoke.

Item 45. The process of any one of items 42-44, wherein an outer diameter of the sidewall is in a range of 20 mm and 40 mm, such as in a range of 25 mm and 35 mm, or even in a range of 30 mm and 31 mm.

Item 46. The process of any one of items 42-44, wherein an inner diameter of the sidewall is in a range of 10 mm to 30 mm, such as in a range of 15 mm to 20 mm, or even in a range of 17 mm to 18 mm.

Item 47. The process of any one of the preceding items, wherein the support yoke has a unitary construction.

Item 48. The process of any one of items 42-47, wherein the sidewall defines a constant thickness.

Item 49. The process of any one of the preceding items, wherein shaping occurs prior to heat treating.

Item 50. A steering support yoke comprising:

a body defining a sidewall and an arcuate upper surface, wherein the body comprises a material having a single phase morphology.

Item 51. The steering support yoke of item 50, wherein the material comprises an aluminum 6061 alloy.

Item 52. The steering support yoke of any one of items 50 and 51, wherein the body has a Vickers Hardness of at least 125, such as at least 127, or even at least 130.

Item 53. A method for producing a support yoke body adapted for use in a rack and pinion steering gear assembly for a vehicle, the method comprising the steps of:

providing a material of specific shape and dimension;
forging of the material to form a shape;
machining the shape to form a support yoke body; and
heat treating the support yoke body.

Item 54. A method of item 53, wherein the heat treatment of the support yoke body comprising the steps:

solutionizing the support yoke body;
quenching of support yoke body in water;
ageing of the support yoke body; and
cooling of the support yoke body in room temperature.

Item 55. A method of assembling a steering support yoke assembly comprising:

forming a support yoke in accordance with any one of the preceding items; and installing the support yoke in a rack and pinion assembly.

Item 56. The method of item 55, wherein the rack and pinion assembly is a subcomponent in a vehicle steering assembly.

Item 57. A rack and pinion assembly comprising:

a rack;
a pinion; and
a support yoke in accordance with any one of items 1-54, wherein the support yoke biases the pinion to the rack.

Item 58. The process, steering yoke, method, or rack and pinion assembly of any one of the preceding items, wherein the support yoke comprises a steering yoke.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A process of forming a support yoke comprising:
providing a material;
shaping the material to form a rough shape, wherein shaping is performed at a temperature less than a melting temperature of the material; and
heat treating the rough shape.

2. The process of claim 1, wherein the process of shaping is performed by cold forging.

3. The process of claim 1, wherein the process further comprises:
machining the rough shape to form a support yoke.

4. The process of claim 1, wherein the process of heat treating is performed by precipitation hardening.

5. The process of claim 1, wherein the process of heat treating is performed by:
solutionizing the support yoke; and
ageing the support yoke.

6. The process of claim 1, wherein the material at least partially comprises an aluminum.

7. The process of claim 1, wherein the support yoke comprises a single phase morphology.

8. The process of claim 1, wherein the support yoke has a more uniform morphology as compared to a steering support yoke formed by a die casting process.

9. The process of claim 1, wherein the support yoke has an average surface roughness, Rₐ, of no greater than 0.6 microns.

10. The process of claim 1, wherein the support yoke has a body defining a sidewall and an arcuate upper surface.

11. A process for producing a support yoke body adapted for use in a rack and pinion steering gear assembly for a vehicle, the process comprising the steps of:
providing a material of specific shape and dimension;
forging of the material to form a shape;
machining the shape to form a support yoke body; and
heat treating the support yoke body.

12. The process of claim 11, wherein the heat treatment of the support yoke body comprising the steps:
solutionizing the support yoke body;
quenching of support yoke body in water;
ageing of the support yoke body; and
cooling of the support yoke body in room temperature.

13. The process of claim 11, wherein the support yoke comprises a steering yoke.

14. The method of claim 11, wherein the process of heat treating is performed by precipitation hardening.

15. The method of claim 11, wherein the process of heat treating is performed by:
solutionizing the support yoke; and
ageing the support yoke.

16. A steering support yoke comprising:
a body defining a sidewall and an arcuate upper surface, wherein the body comprises a material having a single phase morphology.

17. The steering support yoke of claim 16, wherein the material comprises an aluminum 6061 alloy.

18. The steering support yoke of claim 16, wherein the body has a Vickers Hardness of at least 125.

19. The steering support yoke of claim 16, wherein the support yoke has an average surface roughness, Rₐ, of no greater than 0.6 microns.

20. The steering support yoke of claim 16, wherein the support yoke has a unitary construction.
